(19) United States
(12) Patent Application Publication
(10) Pub. No.: US 2026/0132816 A1
(43) Pub. Date: May 14, 2026

(54) ACTIVE MAGNETIC BEARING COMPENSATION BASED ON EXTERNAL INFORMATION

(71) Applicant: Calnetix Technologies, LLC, Cerritos, CA (US)

(72) Inventors: Rasish Khatri, Cerritos, CA (US); Larry Hawkins, Manhattan Beach, CA (US); Scott Tran, Cerritos, CA (US); Ovais Najeeb, Cerritos, CA (US)

(21) Appl. No.: 18/944,265

(22) Filed: Nov. 12, 2024

(51) Int. Cl. F16C 32/04

(52) U.S. Cl. CPC F16C 32/0444; F16C 32/048

(57) ABSTRACT

A system includes a rotating machine, a controller, and a sensor residing apart from the rotating machine. The rotating machine includes a stator, a rotor received in the stator, and a bearing actuator that includes a magnet and an electromagnet. The magnet is configured to generate a constant magnetic flux which induces a constant force on the rotor to position the rotor relative to the stator. The electromagnet is configured to generate a control magnetic flux which induces a variable force on the rotor to position the rotor relative to the stator. The sensor is configured to detect an operating condition external to the rotating machine. The controller, which is coupled to the sensor and the electromagnet, is configured to regulate the variable force applied by the electromagnet based on the external operating condition. The variable force is regulated by changing an electric current that flows through the electromagnet.

### TECHNICAL FIELD

This disclosure generally relates to adjusting the control parameters of an active magnetic bearing system based on external operating condition(s) like ambient noise, altitude, pressure, or external vibration.

### BACKGROUND

Active magnetic bearings are used in various rotating machinery applications, such as high-speed turbines, compressors, and motors. Instead of relying on physical contact to support a rotating shaft (e.g., rotor), active magnetic bearings use electromechanical forces to levitate and control the position of the rotor. Some active magnetic bearings are subject to external dynamics and/or forcing functions that can impact the performance and/or longevity of the bearing.

### SUMMARY

The present disclosure relates to systems and methods for compensating an active magnetic bearing based on measurements of external operation conditions such as external vibration, pressure/flow, altitude, ambient noise, etc. Using the magnetic bearing compensation techniques described herein, a system can adjust magnetic bearing compensator gain based on external input signals, allowing the system to operate in such a way that all minimum standards are met. By using external input signals, the system response can prioritize for different scenarios, such as (i) reduced response to external vibration to lower audible noise or (ii) increased response to improve stability and ignore audible noise. One possible use case is stabilizing axial rotor control in turboexpander generators. By dynamically adjusting the magnetic bearing compensator gain based on fluid flow rates, the system effectively counters the negative stiffness and reduced direct current (DC) gain caused by fluid leakage, thus ensuring consistent axial control and stability of the spinning shaft.

One aspect of the present disclosure can be implemented as a system that includes a rotating machine, a sensor residing apart from (e.g., external to) the rotating machine, and a controller. The rotating machine includes a stator, a rotor received in the stator, and a bearing actuator that includes a magnet and an electromagnet. The magnet is configured to generate a constant magnetic flux which induces a constant force on the rotor to position the rotor relative to the stator. The electromagnet is configured to generate a control magnetic flux which induces a variable force on the rotor to position the rotor relative to the stator. The sensor is configured to detect an operating condition external to the rotating machine. The controller, which is coupled to the sensor and the electromagnet, is configured to regulate the variable force applied by the electromagnet based on the external operating condition. The variable force is regulated by changing an electric current that flows through the electromagnet.

Some implementations may include one or more of the following features.

In some examples, the rotating machine is part of an artificial heart device, the external operating condition is an altitude of the artificial heart device, and the variable force applied by the electromagnet is regulated based on a relationship between the altitude of the artificial heart device and a pressure differential across the artificial heart device.

In some examples, the rotating machine is part of a submarine, the external operating condition is an audible noise level of the submarine, and the variable force applied by the electromagnet is regulated based on the audible noise level of the submarine.

In some examples, the external operating condition is an external vibration and the variable force applied by the electromagnet is regulated to compensate for the external vibration.

In some examples, the rotating machine is part of a turbogenerator, the external operating condition includes measured pressure or flow information, and the variable force applied by the electromagnet is regulated based on a relationship between the measured pressure or flow information and an aerodynamic stiffness of the turbogenerator.

In some examples, the sensor is configured to receive an indication of the external operating condition via a wireless network and relay the indication to the controller.

In some examples, the controller is coupled to a second sensor that detects an operating condition of the rotating machine, and the controller regulates the variable force applied by the electromagnet based on signals received from the sensor and the second sensor.

In some examples, the controller is configured to regulate the variable force applied by the electromagnet in response to the external operating condition exceeding a threshold within a frequency range.

In some examples, the variable force applied by the electromagnet is regulated based on a specified target stiffness of the bearing actuator within the frequency range.

In some examples, the variable force applied by the electromagnet is regulated based on an audible noise generated by the system.

In some examples, the variable force applied by the electromagnet is regulated based on a stability of the rotating machine.

In some examples, the controller is further configured to adjust a gain level of the controller to compensate for a change in the external operating condition detected by the sensor.

In some examples, the sensor is an acoustic sensor configured to detect audible ambient noise, a vibration sensor configured to detect external vibration, or an altitude sensor configured to detect an altitude of the system.

In some examples, the magnet is a permanent magnet that applies a radial and/or axial load to position the rotor relative to the stator.

One aspect of the present disclosure can be implemented as a method for supporting a rotor relative to a stator in a rotating machine. The method includes receiving, from an external sensor residing apart from the rotating machine, an input signal associated with an operating condition external to the rotating machine. The method further includes transmitting, based on the input signal from the external sensor, a control signal indicating a control magnetic flux for an electromagnet in a bearing actuator of the rotating machine. The control signal causes the electromagnet to generate the control magnetic flux which induces a variable force on the rotor to position the rotor relative to the stator.

Some implementations may include one or more of the following features.

In some examples, the method further includes receiving, from a position sensor integral to the rotating machine, a second input signal associated with a position of the rotor relative to the stator.

In some examples, receiving the input signal involves receiving an indication of the operating condition via a wireless network.

In some examples, transmission of the control signal occurs in response to the external operating condition exceeding a threshold within a frequency range.

In some examples, transmitting the control signal comprises transmitting the control signal based on a stiffness of the bearing actuator within the frequency range.

One aspect of the present disclosure can be implemented as an active magnetic bearing system that includes a bearing actuator, an external sensor, and a controller. The bearing actuator is configured to position a rotor of a rotating machine relative to a stator of the rotating machine. The external sensor is configured to detect an operating condition external to the rotating machine. The controller is configured to adjust the position of the rotor relative to the stator based on the external operating condition.

Another aspect of the present disclosure can be implemented as a method for stabilizing the axial control of a rotor in a turboexpander generator by adjusting the compensator gain in response to fluid flow rate changes.

Another aspect of the present disclosure can be implemented as a system comprising a Flow Transmitter/Transducer (FT) connected to an inlet flow valve, a Magnetic Bearing Controller (MBC), and firmware configured to calculate and apply a gain factor based on flow rate.

Another aspect of the present disclosure can be implemented as a method for maintaining stability in axial control by continuously adapting the compensator gain in accordance with real-time flow data.

The method may further include (i) reducing reaction (low stiffness) to high-frequency bending modes and high-frequency broadband noise to reduce audible noise, (ii) reducing vibration into the structure, and/or (iii) adjusting the maximum dynamic load capacity of the system.

### DESCRIPTION OF DRAWINGS

FIG. 1 a cross-sectional schematic of an example active magnetic bearing system in an electric rotating machine.

FIG. 2 is a schematic diagram of a system including the rotating machine, an active MBC, and an external sensor.

FIG. 3 is a schematic diagram showing interactions between the controller, the external sensor, and a network.

FIG. 4 is a schematic diagram showing a power generation system that supports active magnetic bearing compensation based on external information.

FIG. 5 is a flowchart showing an example method for supporting a rotor relative to a stator in a rotating machine.

### DETAILED DESCRIPTION

Industrial active magnetic bearings (AMBs) are tuned to the dynamics of the plant, which includes the rotor, structure, sensor, AMB magnetic properties, and control electronics, to stabilize all modes in all operating conditions of the system (e.g., high damping near rigid-body mode frequencies, low stiffness or high damping near flexible mode frequencies). Some MBCs and industrial AMB systems can measure the frequency response function by using AMB actuators as exciters to characterize the plant dynamics and closed-loop system dynamics. This information can be used to optimize the system such that all minimum standards are met. Minimum standards can include (but are not limited to): having enough stiffness and damping to reduce response to external vibration at frequency ranges of interest; reducing reaction (low stiffness) to high-frequency bending modes and high-frequency broadband noise to reduce audible noise; reducing vibration into the structure; and maximum dynamic load capacity of the system. Additionally, the plant can be subject to variable dynamics and forcing function(s) due to changing speeds, external vibration, aerodynamic effects, inherent electromagnetic properties, degradation/wear/change in balance, etc.

Aspects of the present disclosure provide for scheduling the system based on external analog or digital signals. Various sensors can be connected to external input ports of the MBC, such as microphone to measure audible noise. If the audible noise exceeds a threshold level in a frequency range of interest, the compensator can reduce stiffness in the frequency range to compensate for the net audible noise. Although this may reduce the system's response to external vibration and the long-term stability may be reduced, the system can prioritize audible noise reduction. This is especially useful for manned space and submarine applications.

A microphone array or accelerometers placed on the system housing can help optimize noise for an AMB-supported application aboard a nuclear submarine when an enemy ship is detected in by the onboard radar system. In this scenario, minimum noise can be prioritized over the system's long-term stability until the submarine is outside of the enemy detection zone. However, if an attack is underway, response to external vibration (e.g., due to a missile strike to the hull of the vessel) can be prioritized until the threat has subsided.

In mixers and pumps, the fluid viscosity can have a direct impact on the forces applied to the motor. A viscometer is used to measure the process fluid viscosity. An external temperature measurement of the process fluid can also be used to calculate the viscosity from a temperature curve. When the fluid viscosity is decreased, the bearing stiffness can be reduced to allow for quieter operation.

Turboexpander generators (TEG) are equipped with brush seals to minimize working fluid leakage. Despite this, some leakage persists, increasing as the flow rate rises. This may cause a low-pressure area that affects the axial magnetic bearing, acting like negative stiffness and reducing DC gain. To counteract this reduction in plant gain, the magnetic bearing compensator gain can be increased, thereby stabilizing the axial control channel. An FT or Flow Element (FE) connected to the inlet flow valve relays flow information to the MBC, which then adjusts the compensator gain to maintain axial control of the spinning shaft.

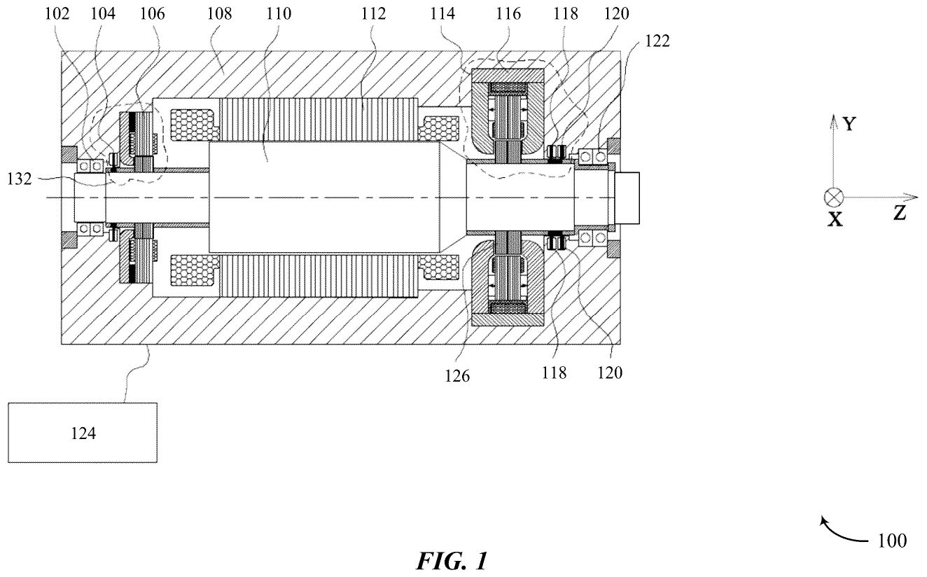

FIG. 1 is a cross-sectional schematic of an example active magnetic bearing system in a rotating machine 100. The rotating machine 100 can be, for example, an electric pump comprising an electric motor 108. The electric motor 108 shown in FIG. 1 has a rotor 110 and a stator 112. The motor 108 can be used as a generator which would convert the mechanical energy of the rotor 110 into electricity. In some embodiments, the rotor 110 of the machine 100 can be supported radially and axially without mechanical contact by means of front and rear radial active magnetic bearings 114 and 132. The front active magnetic bearing 114 provides an axial suspension of the entire rotor 110 and a radial suspension of the front end of the rotor 110, whereas the rear active magnetic bearing 132 provides only radial suspension of the rear end of the rotor 110. When the active magnetic bearings 114 and 132 are inactive, the rotor rests on the mechanical backup bearings 122 and 102. The front backup bearing 122 may provide axial support for the entire rotor 110 and radial support of the rotor front end, whereas the rear backup bearing 102 may provide radial support of the rear end of the rotor 110. There are sufficient radial clearances between the inner diameters of the mechanical backup bearings 122, 102 and the outer diameters of the rotor portions interfacing with those bearing to allow the rotor 110 to be positioned radially without touching the backup bearings 122, 102 when the active magnetic bearings 114 and 132 are activated. Similarly, there are sufficient axial clearances between the backup bearings 122, 102 and the portions of the rotor 110 interfacing with those bearings to allow the rotor 110 to be positioned axially without touching the backup bearings 122 and 102 when the active magnetic bearings 114 and 132 are activated.

The front active magnetic bearing 114 includes a combination radial and axial electromagnetic actuator 116, radial position sensors 118, axial position sensor 120, and control electronics 124. The electromagnetic actuator 116 may be capable of exerting radial and axial forces on the actuator target 126 firmly mounted on the rotor 110. The axial force is applied in the Z-axis direction, and the radial forces are applied in the X-axis direction (directed into the page) and the Y-axis direction. The actuator may have one or more sets of coils corresponding to each of the axes, and the forces may be produced when the corresponding coils are energized with control currents produced by control electronics 124. The position of the front end of the rotor 110 in space is constantly monitored by non-contact position sensors 118 and 120. The non-contact position sensors 118 can monitor radial position of the rotor 110, whereas the position sensor 120 monitors the axial position of the rotor 110.

Signals from the position sensors 118 and 120 may be input into the control electronics 124, which may generate currents in the control coils of the electromagnetic actuator 116 when the rotor is deflected from the desired position, such that these currents may produce forces to push the rotor 110 back to the desired position.

In some examples, smaller axial gain attenuation with frequency and smaller phase difference between the actuator force and the control current in the combination actuator 116 can result in a larger axial load capacity at any particular frequency, and may simplify control design.

The rear active magnetic bearing 132 includes an electromagnetic actuator 106, radial non-contact position sensors 104, and control electronics 124. The rear active magnetic bearing 132 may function similar to the front active magnetic bearing 114. In some implementations, the rear active magnetic bearing 132 may not be configured to control the axial position of the rotor 110, as this function is performed by the front active magnetic bearing 114. Correspondingly, the electromagnetic actuator 106 may not be configured to produce controllable axial forces, and the axial position sensor may be omitted.

The active magnetic bearings 114 and 132 can be implemented as electromagnetic-biased magnetic bearings or permanent magnet-biased magnetic bearings. Both types of bearings produce a magnetic field with two components: a constant bias field and a variable control field. The bias magnetic field of an electromagnetic-biased magnetic bearing is generated by an electrical current in a coil, whereas the bias magnetic field of a permanent magnet-biased magnetic bearing is generated by a permanent magnet. The purpose of this bias is to linearize the applied force versus coil current relationship of the actuators 106 and 116.

The active magnetic bearings 114 and 132 may be implemented as radial magnetic bearings, axial magnetic bearings (e.g., thrust bearings), or combination radial and axial magnetic bearings (e.g., combo bearings). Radial magnetic bearings produce magnetic forces that provide radial support for the rotor 110 in two orthogonal axes, while axial magnetic bearings generate magnetic forces that provide axial support for the rotor 110 (e.g., shaft). Combination bearings, on the other hand, produce magnetic forces that provide both axial and radial support for the rotor 110.

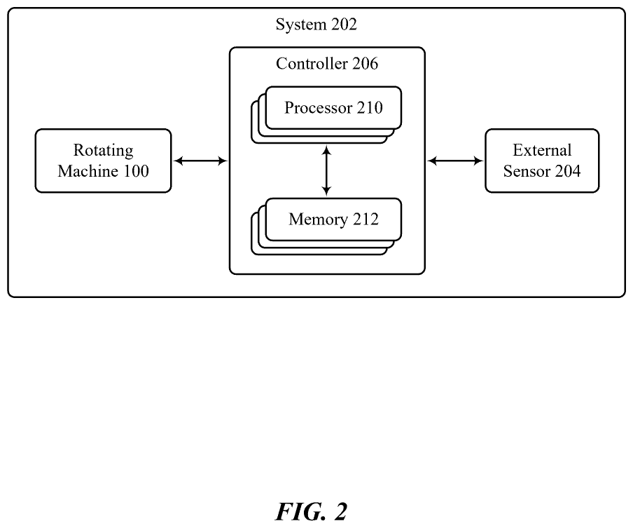

FIG. 2 is a schematic diagram of a system 202 including the rotating machine 100, an active MBC 206, and an external sensor 204. The active MBC 206 includes at least one processor 210 (e.g., one or more general or special-purpose processors) and at least one memory 212 (e.g., one or more volatile or non-volatile memory components/devices) coupled to the at least one processor 210. The at least one memory 212 stores instructions that, when executed by the at least one processor 210, cause the at least one processor 210 to perform the operations described herein.

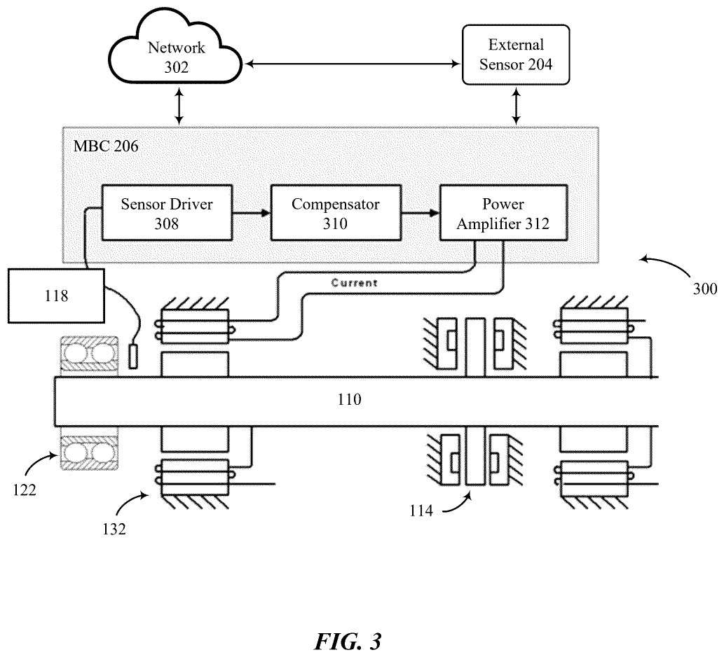

The active MBC 206 has a compensator (such as the compensator 310 shown and described with reference to FIG. 3) that is configured to satisfy one or more of the following constraints: stabilize all modes in all operating conditions of the system 202 (e.g., high damping near rigid-body mode frequencies, low stiffness or high damping near flexible mode frequencies), provide adequate stiffness and damping to reduce response to external vibration at frequency ranges of interest, reduce reaction (low stiffness) to high-frequency bending modes and high-frequency broadband noise to reduce audible noise, reduce vibration into the structure, and maximum dynamic load capacity of the system.

Some of these constraints may conflict with each other. For example, reducing response to external vibration may increase the audible noise of the system 202 (and vice versa). Thus, optimizing the system 202 in such a way that all standards are met can be challenging. Additionally, the system 202 may be subject to variable dynamics and/or variable forcing functions due to changing speed, external vibration, aerodynamic effects (e.g., surge/stall), inherent electromagnetic properties of the system 202, degradation, wear, changes in balance, etc.

The techniques described herein leverage features of the controller 206 (e.g., Wi-Fi connectivity and external input signals) to schedule the system 202 based on external information, which can be obtained via an external sensor 204 (e.g., through direct measurement) or communicated by means of web-based resources.

In one example, the external sensor 204 is a microphone or audio sensor that is connected to an external input port of the controller 206. The microphone may be configured to continually measure an audible noise level of the system 202. If the audible noise exceeds a certain level in a frequency range of interest, the compensator may reduce stiffness in that frequency range to compensate for the net audible noise. In this scenario, response to external vibration and stability may be temporarily less important than minimizing audible noise.

This can be useful for manned space and submarine applications. For example, if the system 202 is a submarine vessel and the rotating machine 100 is part of the submarine's engine, it may be desirable to temporarily decrease the engine's net audible noise (e.g., if an enemy ship is detected by the onboard radar system). In such cases, response to external vibration and stability may be temporarily less important than reducing the engine's noise. However, if an attack is underway, response to external vibration (e.g., due to a missile striking the hull of the vessel) may be more important than audible noise.

As another example, the stiffness of the active magnetic bearing system can be optimized to compensate for measured pressure/flow information of a turbogenerator application. If there is a relationship between aerodynamic negative stiffness and pressure/flow, the system could optimize the active magnetic bearing system based on the relationship. In this scenario, audible noise may temporarily be less important than optimizing stability and response to external vibration.

In another example, the system 202 may be an artificial heart device, such as a left ventricular assist device (LVAD) used for patients who have reached end-stage heart failure. In this scenario, the rotating machine 100 may be a battery-operated, mechanical pump that helps the left ventricle (e.g., the main pumping chamber of the heart) pump blood to the rest of the body. The rotating machine 100 may include an outlet stator 112 and diffuser, an inlet stator 112 and blood-flow-straightener, a motor 108, and a pump housing. In accordance with the techniques described herein, the active MBC 206 may use the external altitude (downloaded from a web-based resource) to adjust the control parameters of the artificial heart device. For example, if there is a known relationship between altitude and pressure differential across the artificial heart device, adjusting the system gain to compensate for the change in pressure differential could help optimize stability.

FIG. 3 is a schematic diagram showing interactions between the active MBC 206, the external sensor 204, and a network 302. FIG. 3 illustrates the relationship between the active MBC 206 and a machine rotor 110 supported on active magnetic bearings 114 and 132. The components of the active magnetic bearing system 300 in the rotating machine 100 are the electromagnetic actuators 106 and 116 and the position sensors 118 and 120. The actuators 106 and 116 and the position sensors 118 and 120 are connected to the active MBC 206 through cables.

In the example of FIG. 3, the active magnetic bearing 132 is depicted as an electromagnetic-biased magnetic bearing and the active magnetic bearing 114 is depicted as a permanent magnet-biased magnetic bearing. In other words, the bias magnetic field of the active magnetic bearing 114 is generated by an electrical current in a coil, whereas the bias magnetic field of the active magnetic bearing 132 is generated by a permanent magnet. In other examples, however, the active magnetic bearing 132 may be implemented as a permanent magnet-biased magnetic bearing and the active magnetic bearing 114 may be implemented as an electromagnetic-biased magnetic bearing. Likewise, the active magnetic bearing 132 is depicted as a radial magnetic bearing (which provides radial support for the rotor 110 in two orthogonal axes) and the active magnetic bearing 114 is depicted as a thrust magnetic bearing (which provides axial support for the rotor 110). In other examples, however, the active magnetic bearing 132 may be implemented as a thrust magnetic bearing and the active magnetic bearing 114 may be implemented as a radial magnetic bearing.

The active magnetic bearings 114 and 132, the position sensors 118 and 120, the active MBC 206, and the connecting cables collectively form the active magnetic bearing system 300. The sensor driver 308 of the active MBC 206 includes a digital signal processor (DSP) board with a sensor electronics section that drives the machine-mounted position sensors 118 and 120 and demodulates (detects) the return signal. The DSP executes a control algorithm (e.g., the compensator 310) and produces a command signal for the power amplifiers 312. The control program in the DSP also handles levitation logic, fault and trend monitoring, and diagnostic functions. The amplifier board converts a command signal from the DSP to drive a control current through the active magnetic bearing actuator coils.

When the rotor 110 moves or vibrates in response to some force (such as a control force, external force, or unbalance), the position sensors 118 and 120 detects the motion and converts it to a voltage using electronics located in the active MBC 206. The sensor voltage is read into the DSP, which compares the rotor position to the set point or desired position to determine the error. This value is what the compensator 310 is configured to minimize. The appropriate correction is calculated from the error using a compensator algorithm. The correction (command) is sent to the power amplifier 312 to drive the corresponding current through the active magnetic bearing actuator coils. The actuators 106 and 116 convert the current into an electromagnetic flux, which creates a force on the rotor 110. The motion or response of the rotor 110 to the control force (and all external forces) are governed by the rotodynamic characteristics of the rotating machine 100.

The active magnetic bearing system 300 (also referred to as the plant) produces stiffness and damping forces that control rotor position. In contrast to the mechanical or fluid forces provided by the backup bearings 122, magnetic bearing forces are produced by a magnetic field at the actuator surface. The active magnetic bearing produces reaction forces opposing the rotor displacement (stiffness) and reaction forces out of phase with rotor displacement (damping). The stiffness and damping of the system vary with frequency of excitation. The compensator 310, together with characteristics of the position sensors 118 and 120, the power amplifier 312, and the magnetic bearing actuators 106 and 116 of the active magnetic bearings 114 and 132, define the stiffness and damping characteristics of the magnetic bearing system 300.

The characteristics of the magnetic bearing compensator 310, fault limits, and other options are defined in a parameter, which is compiled to create an image that can be stored in flash on the DSP board in the active MBC 206. Machine-specific characteristics, such as sensor calibration values, operating hours, fault log, and event log are stored in non-volatile random-access memory (RAM) on the DSP board.

In accordance with aspects of the present disclosure, the active MBC 206 may be in electronic communication with an external sensor 204 and/or a network 302. The external sensor 204 may be an acoustic sensor (such as a microphone) configured to measure the audible ambient noise of the system 202 (e.g., audible noise external to the active magnetic bearing system 300), a vibration sensor configured to detect external vibration, an elevation sensor configured to detect an absolute or relative altitude of the rotating machine 100, a pressure sensor configured to measure the pressure or aerodynamic flow of the system 202, etc. In some implementations, the network 302 is a wireless local area network (WLAN) that supports a Wi-Fi protocol. The active MBC 206 may communicate with one or more web-based resources via the network 302 to obtain external information (such as the altitude of the system 202 or the relationship between altitude and pressure differential) that can be used to compensate the active magnetic bearing system 300.

As described herein, industrial active magnetic bearings 114 and 132 are tuned based on the dynamics of the active magnetic bearing system 300, which includes the rotor 110, the stator 112, position sensors 118 and 120, active magnetic bearing properties, and control electronics. The active MBC 206 can measure frequency response function by using active magnetic bearing actuators 106 and 116 to characterize the plant dynamics and closed-loop system dynamics. In some implementations, a programmable logic controller (PLC) may also direct information to the active MBC 206 to gain schedule the compensator 310. The techniques described herein provide for scheduling the compensator 310 based on external information as well.

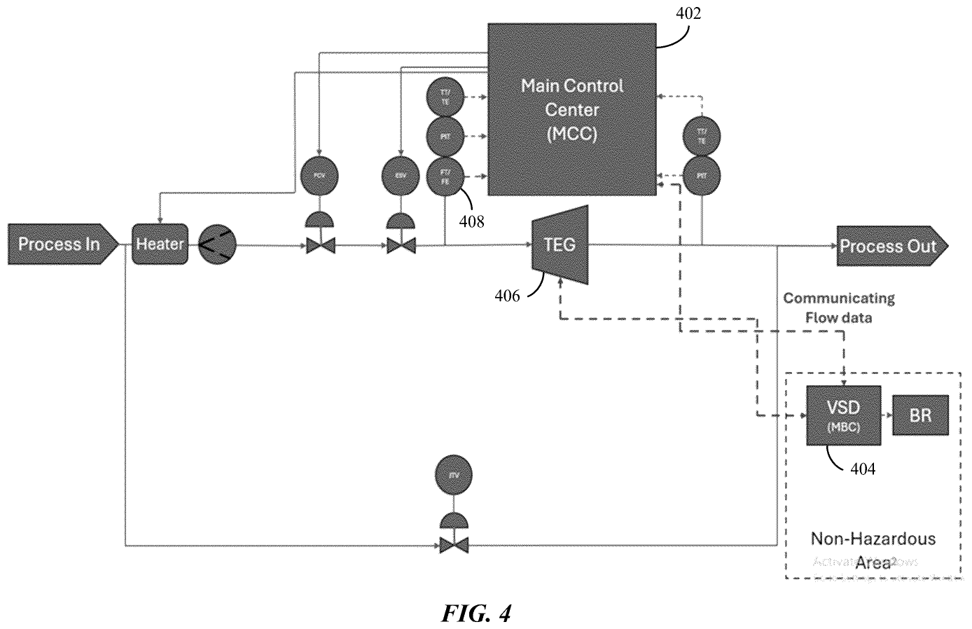

FIG. 4 is a schematic diagram showing a power generation system that supports active magnetic bearing compensation based on external information. The power generation system depicted in FIG. 4 includes a main control center (MCC) 402, a variable speed drive (VSD) 404, and a TEG 406. The VSD 404 may include an MBC, such as the active MBC 206 shown and described with reference to FIG. 2.

As working fluid flow through the TEG 406 increases, a drop in low-frequency gain may be observed due to increased negative stiffness in the rotor 110. An unadjusted control/compensator gain can lead to rotor instability and displacement, stemming from reduced baseline plant characteristics. FIG. 4 depicts a schematic of the power generation system, illustrating the flow of information between components of the system. An FT/FE 408 at the inlet flow valve records and sends working fluid flow data to the MCC 402 at the customer site. The MCC communicates this data to the VSD 404 (e.g., the MBC), which adjusts the control gain to compensate for the low-frequency axial plant gain drop, stabilizing the spinning shaft of the TEG 406.

Low-frequency gain decreases with increased gas flow. Gain scheduling ensures that (i) the inherent response of the plant transfer function remains constant and (ii) the low plan gain does not deviate from what is anticipated. In the absence of MCC-MBC communication, compensator gain remains static despite increased flow. With gain scheduling based on flow rate, the MBC elevates compensator gain to offset plant gain loss. Continuous flowrate communication from the customer to the MBC enables the MBC firmware to calculate and apply a TEG flow rate factor to the controller gain, thereby stabilizing the shaft. The MBC firmware calculates the gain factor according to the equation shown below:

TEG_Flow_Rate_Factor=(1+Flow_Gain_Slope*Measured_Flow_Rate)

As working fluid flow through the TEG 406 increases, the unbalance response of the spinning shaft increases (e.g., the disturbance response increases). However, once axial gain scheduling is applied, the unbalance response as a function of frequency drops in turn, making the rotor 110 more stable axially.

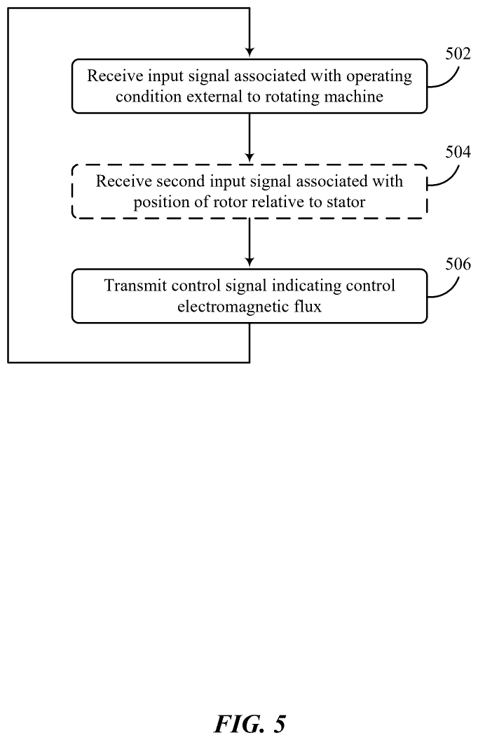

FIG. 5 is a flowchart showing an example method for supporting a rotor 110 relative to a stator 112 of a rotating machine 100. In some implementations, the rotating machine 100 may be part of a larger system 202, such as an artificial heart device, a submarine, or a turbogenerator (as described with reference to FIG. 2).

At 502, an input signal associated with an external operating condition is received from an external sensor 204 residing apart from the rotating machine 100. In some examples, the input signal is received via a wireless network 302 (e.g., using Wi-Fi). For example, the external sensor 204 may provide an indication of the external operating condition (such as a current or measured value of the external operating condition) to the active MBC 206. The external sensor 204 may be, for example, an acoustic sensor configured to detect audible ambient noise, a vibration sensor configured to detect external vibration, or an altitude sensor configured to detect an altitude of the rotating machine 100.

At 504, a second input signal associated with a position of the rotor 110 relative to the stator 112 is optionally received from one of the position sensors 118 and 120, which are integral to the rotating machine 100.

At 506, a control signal is transmitted based on the input signal received from the external sensor 204 and/or the second input signal received from the position sensors 118 and 120. The control signal indicates a control magnetic flux for an electromagnet in a bearing actuator of the rotating machine 100 (such as the actuator 116 shown and described with reference to FIG. 1). The control signal may cause the electromagnet to generate the control magnetic flux, which induces a variable force on the rotor 110 to position the rotor 110 relative to the stator 112.

In some examples, transmission of the control signal occurs in response to the external operating condition (such as a measured pressure or flow of the system 202) exceeding a threshold within a frequency range. Additionally, or alternatively, the control signal may be transmitted based on an audible noise level of the system 202 or a stiffness of the bearing actuator within a frequency range. One or more operations of the method 500 may be periodically repeated to account for changes in the external operating condition, changes to the characteristics of the system 202, positional changes of the rotor 110, etc.

A number of implementations have been described. Nevertheless, various modifications can be made without departing from the spirit and scope of the present disclosure. Accordingly, other implementations are within the scope of the following claims.

What is claimed is:

1. A system, comprising:
a rotating machine comprising:
a stator;
a rotor received in the stator;
a bearing actuator comprising:
a magnet configured to generate a constant magnetic flux which induces a constant force on the rotor to position the rotor relative to the stator;
an electromagnet configured to generate a control magnetic flux which induces a variable force on the rotor to position the rotor relative to the stator;
a sensor residing apart from the rotating machine and configured to detect an operating condition external to the rotating machine; and
a controller coupled to the sensor and the electromagnet, the controller configured to regulate the variable force applied by the electromagnet based on the external operating condition, the variable force regulated by changing an electric current that flows through the electromagnet.

2. The system of claim 1, wherein regulating the variable force applied by the electromagnet comprises adjusting a compensator gain of the controller based on the external operating condition.

3. The system of claim 1, wherein the rotating machine is part of a turboexpander generator, and wherein regulating the variable force applied by the electromagnet comprises adjusting a compensator gain of the controller to stabilize axial control of the rotor in response to fluid flow rate changes detected by the sensor.

4. The system of claim 1, further comprising:
an inlet flow valve;
a flow transmitter or transducer connected to the inlet flow valve; and
firmware configured to calculate and apply a gain factor based on a flow rate detected by the sensor.

5. The system of claim 1, wherein regulating the variable force applied by the electromagnet comprises continuously adjusting a compensator gain of the controller to maintain axial control stability of the rotating machine in accordance with real-time flow data measured by the sensor.

6. The system of claim 1, wherein regulating the variable force applied by the electromagnet comprises (i) reducing a reaction of the rotating machine to high-frequency bending modes and high-frequency broadband noise to reduce audible noise, (ii) reducing vibration into a structure of the rotating machine, or (iii) adjusting a maximum dynamic load capacity of the system.

7. The system of claim 1, wherein:
the rotating machine is part of an artificial heart device;
the external operating condition comprises an altitude of the artificial heart device; and
the variable force applied by the electromagnet is regulated based on a relationship between the altitude of the artificial heart device and a pressure differential across the artificial heart device.

8. The system of claim 1, wherein:
the rotating machine is part of a submarine;
the external operating condition comprises an audible noise level of the submarine; and
the variable force applied by the electromagnet is regulated based on the audible noise level of the submarine.

9. The system of claim 1, wherein:
the rotating machine is part of a submarine;
the external operating condition comprises an external vibration; and
the variable force applied by the electromagnet is regulated based on the external vibration.

10. The system of claim 1, wherein:
the rotating machine is part of a turbogenerator;
the external operating condition comprises measured pressure or flow information; and
the variable force applied by the electromagnet is regulated based on a relationship between the measured pressure or flow information and an aerodynamic stiffness of the turbogenerator.

11. The system of claim 1, wherein:
the controller is coupled to a second sensor that detects an operating condition of the rotating machine; and
the controller regulates the variable force applied by the electromagnet based on signals received from the sensor and the second sensor.

12. The system of claim 1, wherein the controller is configured to regulate the variable force applied by the electromagnet in response to the external operating condition exceeding a threshold within a frequency range.

13. The system of claim 8, wherein regulating the variable force applied by the electromagnet comprises regulating the variable force applied by the electromagnet based on a specified target stiffness of the bearing actuator within the frequency range.

14. The system of claim 1, wherein regulating the variable force applied by the electromagnet comprises regulating the variable force applied by the electromagnet based on an audible noise generated by the system.

15. The system of claim 1, wherein regulating the variable force applied by the electromagnet comprises regulating the variable force applied by the electromagnet based on a stability of the rotating machine.

16. The system of claim 1, wherein the controller is further configured to adjust a gain level of the controller to compensate for a change in the external operating condition detected by the sensor.

17. The system of claim 1, wherein the sensor comprises an acoustic sensor configured to detect audible ambient noise, a vibration sensor configured to detect external vibration, or an altitude sensor configured to detect an altitude of the system.

18. A method of supporting a rotor relative to a stator in a rotating machine, the method comprising:
receiving, from an external sensor residing apart from the rotating machine, an input signal associated with an operating condition external to the rotating machine; and
transmitting a control signal based on the input signal from the external sensor, the control signal indicating a control magnetic flux for an electromagnet in a bearing actuator of the rotating machine, the control signal causing the electromagnet to generate the control magnetic flux which induces a variable force on the rotor to position the rotor relative to the stator.

19. The method of claim 18, further comprising receiving, from a position sensor integral to the rotating machine, a second input signal associated with a position of the rotor relative to the stator.

20. An active magnetic bearing system, comprising:
a bearing actuator configured to position a rotor of a rotating machine relative to a stator of the rotating machine;
an external sensor configured to detect an operating condition external to the rotating machine; and
a controller configured to adjust the position of the rotor relative to the stator based on the external operating condition.
